(19) United States
(12) Patent Application Publication
(10) Pub. No.: US 2007/0162635 A1
(43) Pub. Date: Jul. 12, 2007

(54) Command determination control apparatus and apparatus control method

(75) Inventor: Hideo Shimokawa, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/636,535

(22) Filed: Dec. 11, 2006

(30) Foreign Application Priority Data
Dec. 26, 2005 (JP) 2005-373573

(51) Int. Cl. G06F 3/00

(52) U.S. Cl. 710/15

(57) ABSTRACT

According to one embodiment, when a command has been detected, while data transfer is in progress, it is determined that the command has been unintentionally issued, and a mode move is limited. A control apparatus has a command decoder circuit, a data control circuit, a state control circuit which analyzes the content of the command, and then, controls states of the data control circuit and a memory unit, a detecting unit which detects a command indicating a state move, a data transfer state determining unit which, when the command has been detected, determines whether or not the data control unit is in data transfer, and a move mode setting unit which, when the data transfer state determining unit is in data transfer, moves an operating mode to an idle state.

### CROSS-REFERENCE TO RELATED APPLICATIONS

This application is based upon and claims the benefit of priority from Japanese Patent Application No. 2005-373573, filed Dec. 26, 2005, the entire contents of which are incorporated herein by reference.

### BACKGROUND

1. Field

One embodiment of the invention relates to a command determination control apparatus and an apparatus control method that are effective as an interface processing unit between a memory unit and a host device, the apparatus and method preventing a malfunction and improving reliability of the apparatus.

2. Description of the Related Art

As a type of a semiconductor memory card, a multimedia card (registered trademark) has been developed, and its standard is known as an MMC standard. An operation based on this standard can be carried out in an MMC mode and also can be carried out in a Serial Peripheral Interface (SPI) mode. In addition, a further improvement of such a multimedia card (registered trademark) includes an SD card (registered trademark).

The memory card of this type is used after being mounted on a slot of a variety of host devices such as a personal computer, a PDA, a camera, and a portable cellular phone, for example. Documents describing a use state of the memory card of this type include: Jpn. Pat. Appln. KOKAI Publication Nos. 2004-185273 (document 1) 2003-091703 (document 2).

In the conventional technique described above, in a state of connection between the host device and the memory card, when the memory card has been changed to a different one, an electric potential at which the connection pins have been pulled up is stabilized so as to be applied to the memory card after changed or an erroneous operation is prevented.

In the meantime, an operation using the MMC mode and an operation using the SPI mode are different from each other in role of terminals which connect the host device and the memory device. For example, while a certain terminal (hereinafter, referred to as a DAT3 terminal) is reserved and set to be open or logic 1 in the MMC mode, it is set to be a negative logic as a selection terminal (chip select) in the SPI mode. In addition, another terminal (hereinafter, referred to as a CMD terminal) functions as an input/output terminal for carrying out command input and response signal output in the MMC mode, and is used for data and command input from the host device to the memory device in the SPI mode.

Here, when a data transfer operation is performed in the MMC mode, the fact that DAT3 terminal has been incidentally lowered to a negative value and the fact that CMD0 has been issued at a CMD terminal may be misinterpreted. In such a case, the facts may be interrupted as an SPI mode move command. At this time, the memory device may move to the SPI mode and may not be able to return to the MMC mode. Namely, in the MMC standard, means for determining whether or not an incoming signal with respect to the DAT3 terminal has arrived as chip select information or has arrived as essential data is not defined.

Thus, there is only one method for returning from the SPI mode to the MMC mode as described above, i.e., temporarily turning OFF the power to reset the apparatus.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an illustrative block diagram showing an embodiment of the present invention;

FIG. 2 is a flow chart adapted to illustrate an example of an operation of an apparatus according to the present invention; and

FIG. 3 is a timing chart adapted to illustrate an example of an operation of the apparatus according to the present invention.

### DETAILED DESCRIPTION

Various embodiments according to the invention will be described hereinafter with reference to the accompanying drawings.

In an embodiment according to the present invention, it is an object to provide a command determination control apparatus and an apparatus control method capable of improving an operation when a command CMD0 has arrived and preventing a move to an undesired state.

According to one embodiment of the present invention, there is provided a command determination control apparatus, comprising: a plurality of external terminals including a command terminal to which a command is inputted and a data terminal for data; a command decoder circuit which decodes a command from the command terminal; a data control circuit connected between the data terminal and a memory unit to capture data from the data terminal to the memory unit and to control data output from the memory unit to the data terminal; a state control circuit which analyzes contents of the command decoded by the command decoder circuit, and then, controls states of the data control circuit and the memory unit; and a detecting unit associated with the state control circuit and detecting a command (CMD0), indicating a state move, inputted from the command terminal.

Further, the apparatus has: a data transfer state determining unit which, when the detecting unit has detected a specific command (CMD0) indicating the state move, determines whether or not the data control unit is in data transfer; and a move mode setting unit which, when the data transfer state determining unit has determined that data transfer is in progress, moves an operating mode to an idle state.

According to the means described above, when a command (CMD0) for instructing state move has been detected, while data is being transferred, it is determined that the command has been unintentionally issued, a mode move can be limited, and the reliability of apparatus operation can be obtained.

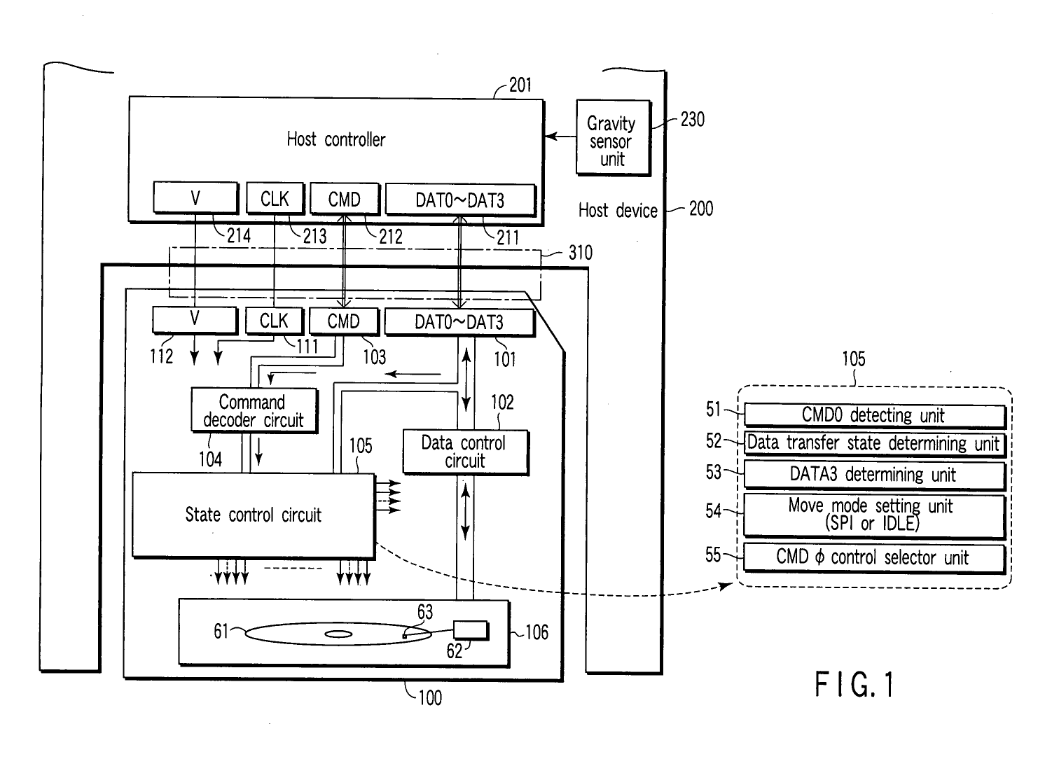

Now, embodiments of the present invention will be described with reference to the accompanying drawings. FIG. 1 shows a terminal to which the present invention has been applied, for example, a portion of a variety of host devices such as a personal computer, a personal digital assistant (PDA), a digital camera, a movie camera, and a portable cellular phone, for example. The present apparatus can be applied as an interface processing unit, and thus, may be provided between a hard disk drive and a personal computer without being limited thereto.

FIG. 1 shows an example in which an interface processing unit between a host device 200 and a memory device 100 has been applied. The memory device 100 has: a data (DAT0, DAT1, DAT2, DAT3) terminal 101; a command (CMD) terminal 103; a clock (CLK) terminal 111; and a power supply voltage (V1, V2, Vcc) terminal 112. The data terminal 101 is connected to a data control circuit 102 and this data control circuit 102 is connected to a data input/output unit of a magnetic disk (memory unit) 106. In addition, the command terminal 103 is connected to a command decoder circuit 104.

A command decoded by the command decoder circuit 104 is inputted to a state control circuit 105. Data DAT3 from the data terminal 101 described previously is also inputted to this state control circuit 105.

The state control circuit 105 basically analyzes a command, and then, controls the data control circuit 102 and the memory unit 106. In addition, the state control circuit 105 can switch a state of the memory device to an operation using the MMC mode or an operation using the SPI mode.

The memory device 100 described above is connected to a host controller 201 of the host device 200 via a connector unit 310. In this example, it is assumed that a data terminal 211, a command terminal 212, a clock terminal 213, and a power supply voltage (V1, V2, Vcc) terminal 214 are provided in the host controller 201 as well, to be associated with the above described data (DAT0, DAT1, DAT2, DAT3) terminal 101; command (CMD) terminal 103; clock (CLK) terminal 111; and power supply voltage (V1, V2, Vcc) terminal 112, respectively.

Now, a basic operation of the memory device 100 in the MMC mode will be described here. Now, it is assumed that the command decoder circuit 104 of the memory device 100 has received a command issued from the host controller 201. At this time, the command decoder circuit 104 interprets the content of the command, and then, carries out a processing operation that corresponds to that command.

For example, if the content of the command indicates a move of a state, that state move command is passed to the state control circuit 105. The state control circuit 105 switches an operation from the MMC mode to the SPI mode in response to the state move command. In addition, if the content of the command is a data transfer command relating to data transfer, the data control circuit 102 is controlled via the state control circuit 105. In this manner, the data control circuit 102 carries out data transfer control between the memory unit 106 and the host controller 201.

The state control circuit 105 has: a detecting unit 51 which detects a specific command (CMD0) indicating a state move to be inputted from a command terminal; and a data transfer state determining unit 52 which, when the detecting unit 51 has detected the specific command (CMD0) indicating a state move, determines whether or not the data control circuit 102 is in data transfer.

In addition, this control circuit has a move mode setting unit 52 which, when the data transfer state determining unit 52 has determined that data transfer is in progress, moves an operating mode to an idle state.

Furthermore, this control circuit has a selector unit (CMD0 control selector unit 55) relating to switch of a move mode. This selector unit 55 can select whether to disable or enable an operation of determining data transfer information in the data transfer state determining unit 52. In this manner, whether or not to limit a move to the SPI mode during data transfer can be selected. In addition, it is possible to set a move to the SPI mode during data transfer.

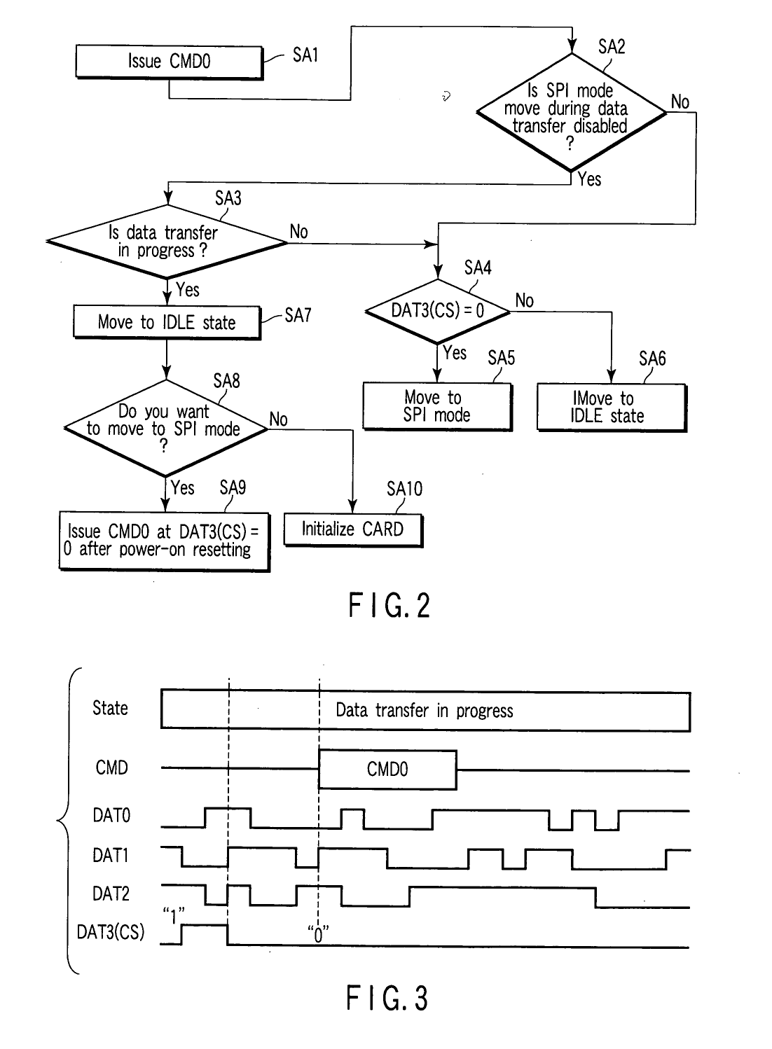

Now, a characterizing operation will be described with reference to FIGS. 2 and 3. The state control circuit 105 can judge the content of the data DAT3. Now, it is assumed that the state control circuit 105 has detected a state move command (step SA1). Then, it is assumed that a move to the SPI mode during data transfer is not disabled (step SA2). At this time, it is checked whether or not a command CMD0 detected after power-on resetting is a first CMD0, and the following processing operation is determined based on the content of the data DAT3 at this time.

That is, in the case where the data DAT3 is “0” (step SA4), a control for moving to the SPI mode is made (step SA5). In addition, in the case where the data DAT3 is not “0” in step SA4, a control for moving to an idle (IDLE) state is made (step SA6). In addition, in the case where a move to the SPI mode during data transfer has been disabled in step SA2 and it has been determined that no data transfer occurs (step SA3), it is checked whether or not a command CMD0 after power-on resetting is a first CMD0. Then, the following processing operation is determined based on the content of the data DAT3 at this time. That is, in the case where the data DAT3 is “0” (step SA4), a control for moving to the SPI mode is made (step SA5). In addition, in the case where the data DAT3 is not “0” in step SA4, a control for moving to the idle (IDLE) state is made (step SA6).

In addition, in the case where it has been determined that a state in which the command CMD0 has been received indicates that data transfer is in progress in step SA3, the state control circuit 105 makes a control for the memory device 100 to move to the idle (IDLE) state without checking the content of the data DAT3 (step SA7).

Namely, when data transfer is in progress, a processing operation relevant to the command CMD0 is limited so as to move to the idle (IDLE) state, making it possible to prevent a processing operation in the case where DAT3 is unintentionally “0”. In this idle state, a standby state is established to wait for a next command to be issued from the host device.

In the IDLE state, in the case where a user wants to move to the SPI mode, an operation is made at the side of the host device 200, a power-on reset operation is made, the data DAT3 is set to “0”, and a command CMD0 is outputted (steps SA8 and SA9). In addition, in the IDLE state, if the user makes an initializing operation, a processing operation of initializing a memory device is executed (step SA10).

In the meantime, the command CMD0 described above is issued during data transfer in the following case.

Although this is not specified in the present MMC standard, a command CMD0 is used as a command for interrupting data transfer in the apparatus according to the present embodiment. During data transfer, for example, in the case where the apparatus is dropped, or in the case where a strong impact is applied thereto, a transfer operation of the data control circuit 102 must be stopped to prevent damage to a medium 61 and a head 63 in the memory unit 106. Therefore, when a gravity sensor unit 230 provided in the apparatus has sensed a sudden gravity change, the gravity change sense signal is supplied to the host controller 201. Upon receiving the gravity change sense signal, the host controller 201 issues the command CMD0 described above. In this manner, damage to the medium 61 can be preventing by stopping the transfer operation of the data controller circuit 102, controlling an actuator 62, and then, evacuating the head 63 to a safe position. The memory unit 106 may be a semiconductor memory, a memory card and the like.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A command determination control apparatus, comprising:
a plurality of external terminals including a command terminal to which a command is inputted and a data terminal for data;
a command decoder circuit which decodes a command from the command terminal;
a data control circuit connected between the data terminal and a memory unit to capture data from the data terminal to the memory unit and to control data output from the memory unit to the data terminal;
a state control circuit which analyzes contents of the command decoded by the command decoder circuit, and then, controls states of the data control circuit and the memory unit;
a detecting unit associated with the state control circuit, the detecting unit being capable of indicating a state move to be inputted from the command terminal;
a data transfer state determining unit which, when the detecting unit has detected a specific command indicating the state move, determines whether or not the data control unit is in data transfer; and
a move mode setting unit which, when the data transfer state determining unit has determined that data transfer is in progress, moves an operating mode to an idle state.

2. The command determination control apparatus according to claim 1, further comprising a selector unit relating to a switch of a move mode,
wherein whether to disable or enable an operation of determining a data transfer state of the data transfer state determining unit can be set by means of this selector unit.

3. The command determination control apparatus according to claim 1, wherein the memory unit is a memory card.

4. The command determination control apparatus according to claim 1, wherein the memory unit has a disk shaped memory medium.

5. The command determination control apparatus according to claim 1, wherein the specific command is outputted from a host controller of a host device.

6. The command determination control apparatus according to claim 1, wherein the specific command is a signal outputted from a host controller of a host device, and the host controller outputs the specific command when a gravity change sense signal has been sensed.

7. A method for controlling an apparatus based on command determination, the apparatus having: a plurality of external terminals including a command terminal to which a command is inputted and a data terminal for data; a command decoder circuit which decodes a command from the command terminal; a data control circuit connected between the data terminal and a memory unit to capture data from the data terminal to the memory unit and to control data output from the memory unit to the data terminal; and a state control circuit which analyzes contents of the command decoded by the command decoder circuit, and then, controls states of the data control circuit and the memory unit, the method comprising:
detecting a specific command capable of indicating a state move to be inputted from the command terminal;
when the detecting unit has detected a specific command indicating the state move, determining whether or not the data control unit is in data transfer; and
when the data transfer state determining unit has determined that data transfer is in progress, moving an operating mode to an idle state.

8. The apparatus control method based on command determination according to claim 7, wherein a selection relating to switch of a move mode can be further made, and whether to disable or enable an operation of determining a data transfer state of the data transfer state determining unit can be set by the selection.

9. The apparatus control method based on command determination according to claim 7, wherein the specific command is outputted from a host controller of a host device.

10. The apparatus control method based on command determination according to claim 7, wherein the specific command is a signal outputted from a host controller of a host device, and the host controller outputs the specific command when a gravity change sense signal has been sensed.

11. The apparatus control method based on command determination according to claim 7, wherein a standby state is established in the idle state so as to want for a next command to be issued from the host device.

12. The apparatus control method based on command determination according to claim 7, wherein the memory unit is a disk device, the specific command is a signal outputted from a host controller of a host device, the host controller outputs the specific command when a gravity change sense signal has been sensed, and, in response to the gravity change sense signal, the disk device evacuates a head device.
